(19) United States
(12) Patent Application Publication
(10) Pub. No.: US 2020/0265622 A1
(43) Pub. Date: Aug. 20, 2020

(54) FORMING SEAM TO JOIN IMAGES

(71) Applicant: Microsoft Technology Licensing, LLC, Redmond, WA (US)

(72) Inventors: Gustaf Georg PETTERSSON, Bellevue, WA (US); Karim Henrik BENCHEMSI, Kirkland, WA (US)

(73) Assignee: Microsoft Technology Licensing, LLC, Redmond, WA (US)

(21) Appl. No.: 16/277,683

(22) Filed: Feb. 15, 2019

(51) Int. Cl. G06T 11/60; G06T 7/174; G06K 9/62; G06T 7/11; G06K 9/72

(52) U.S. Cl. CPC G06T 11/60; G06T 7/174; G06K 9/628; G06K 2209/27; G06K 9/726; G06T 2207/20224; G06T 7/11

(57) ABSTRACT

One example method includes obtaining a first image of a first portion of a scene, obtaining a second image of a second portion of the scene, the second portion of the scene at least partially overlapping the first portion of the scene, based on a determined likelihood that pixels within the first image and/or the second image correspond to one or more classes of objects, determining a path for joining the first image and the second image within a region in which the first image and the second image overlap, and forming a seam based on the path determined for joining the first image and the second image.

### BACKGROUND

A field of view of a camera may not be sufficiently large to obtain a desired image of a scene. Thus, two or more images captured by one or more cameras may be merged together to form a panoramic image of the scene. In some examples, forming a panoramic image comprises aligning adjacent image frames and “blending” the images together in a region in which the images overlap. However, this solution may produce a final blended image containing artifacts, for example, due to misalignment in the region in which the images overlap. In other examples, forming a panoramic image comprises cutting an image and stitching the cut image to a cut portion of another image.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to joining images together via a seam. One example provides a method comprising obtaining a first image of a first portion of a scene and obtaining a second image of a second portion of the scene, with the second portion at least partially overlapping the first portion. Based at least on a determined likelihood that pixels within the first image and/or the second image correspond to one or more classes of objects, a path is determined for joining the first image and the second image within a region in which the first image and the second image overlap. Based on the path determined, a seam is formed for joining the first image and the second image.

### BRIEF DESCRIPTION OF THE DRAWINGS

FIG. 1 is a block diagram illustrating an example use environment for an image capture device configured to join two or more images via a seam.

FIGS. 2A and 2B schematically show two consecutive images acquired by a camera of an example image capture device.

FIGS. 3A through 6B schematically show examples of image probability maps.

FIG. 7 schematically shows the example images of FIGS. 2A and 2B as projected onto a canvas after alignment and registration.

FIG. 8 schematically shows an example difference map for a region in which the example images of FIGS. 2A and 2B overlap.

FIG. 9 schematically shows the example image probability maps of FIGS. 3A and 3B and the difference map of FIG. 8 projected onto the example images of FIGS. 2A and 2B.

FIG. 10 schematically shows a panoramic image comprising a seam for joining the example images of FIGS. 2A and 2B.

FIG. 11 schematically depicts an example use environment for stitching together images obtained from multiple cameras.

FIG. 12 schematically depicts an example cost map-based path for joining two adjacent images shown in FIG. 12.

FIG. 13 schematically shows an example panoramic image formed by joining the images shown in FIG. 12 via cost-based seams.

FIG. 14 is a flowchart illustrating an example method for forming a seam between first image and a second image.

FIG. 15 is a block diagram illustrating an example computing system.

### DETAILED DESCRIPTION

As mentioned above, multiple images may be stitched together to form a panoramic image, which may appear as an image captured by a single camera. In some examples, a single camera (e.g. an integrated camera of a mobile device) captures multiple images of a scene as the camera lens rotates and/or translates. In a more specific example, an integrated camera of a mobile phone may capture a plurality of images as the user moves the phone. Consecutive images may at least partially overlap in terms of the scene imaged in each frame. However, forming a panoramic image from images acquired by a single camera involves merging images captured at different points in time, during which the camera and/or objects within the scene have moved. For example, adjacent images taken at different points in time may include a person or other foreground object at different positions relative to a background. Further, merging the images may result in perceptible parallax artifacts in overlapping regions among consecutive images, which may be exacerbated in instances that the camera does not undergo pure rotational motion during image acquisition.

In other examples, the presence of artifacts arising from movement within a scene may be mitigated by merging temporally synchronized images acquired by multiple cameras. For example, a video conference device or other multi-camera rig may include a plurality of outward-facing cameras that synchronously acquire images of a use environment (e.g. a conference room, a warehouse, etc.). However, to form a panoramic image showing a larger portion of the use environment than a single camera can capture, the multiple cameras may have noncoinciding camera centers. Thus, images captured by different cameras may contain differences based upon a relative position and/or orientation of a feature(s) in the use environment to each camera, which may introduce parallax artifacts in a panoramic image formed from the images.

When joining overlapping images acquired by one or more cameras, one solution for mitigating parallax artifacts is placing a seam that joins two adjacent images at a location where the images exhibit suitably high similarity (e.g. a pixel-wise difference below a threshold). In some examples, a seam joining adjacent images may be imperceptible when placed in a noisy and/or high-frequency patterned area (e.g. grass), as color and/or intensity differences along the seam may be suitably small between the two images, even when the images are misaligned. In contrast, a seam placed in a high difference area between the two images may produce a visible discontinuity at the seam.

In some examples, the location of the seam may be determined based on differences between the two images. In some examples, pixel-wise differences between the images may be calculated by subtracting pixel intensity and/or color of each pixel of one image from a corresponding pixel intensity and/or color of another image to obtain a pixel-by-pixel measure of similarity or dissimilarity between the two images. In different examples, such pixel-by-pixel subtraction may be performed using all pixels of both images, or using portions of pixels in each image, such as within a region in which the images overlap. In such a region of overlap, the seam that joins one image to an adjacent image may be selected to follow a path of least pixel-wise difference between the two images.

However, placing a seam based solely on differences between the images may yield less than desirable results when the region in which two adjacent images overlap comprises an object that is readily recognizable or otherwise familiar to a human viewer. Such objects may include, but are not limited to, persons, animals, vehicles, office supplies, or another recognizable class of objects. Such objects may comprise common shapes, contours, textures and/or other features that humans expect to see in the object. In such scenarios, while pixel-wise differences between the images may be suitably small for overlapping pixels corresponding to the person, animal, or other recognizable object, a seam that intersects such overlapping pixels may be readily perceptible to a human observer, and may thereby create a noticeable distortion. In a more specific example, a seam placed through a person may alter a geometry of the person, such as shifting a portion of the person's face with respect to another portion of the person's face. As an observer may be sensitive to deviations in the physical appearance of certain commonly recognized objects, and particularly to deviations in people and faces, such seam placement may not form a visually pleasing or realistic panoramic image.

Thus, examples are disclosed that relate to joining images in a manner that avoids seam placement through one or more classes of objects. Briefly, for each of two or more images to be joined together, a probability map may be generated describing a probability of a pixel within the image belonging to one or more classes of objects. The images and respective probability maps for each image may be projected onto a virtual canvas and differences between adjacent images, at least within a region in which the adjacent images overlap, may be calculated. For each pair of adjacent images, a cost map may be generated based on the respective probability maps and the differences between the two images. In the region in which the adjacent images overlap, a path is determined based on a determined likelihood that pixels within the first image and/or the second image correspond to one or more classes of objects, and this path is used to form a seam at which the two images are cut and joined. In this manner, the perceptibility of the seam may be reduced as compared to methods that do not consider a likelihood of the seam intersecting one or more classes of objects.

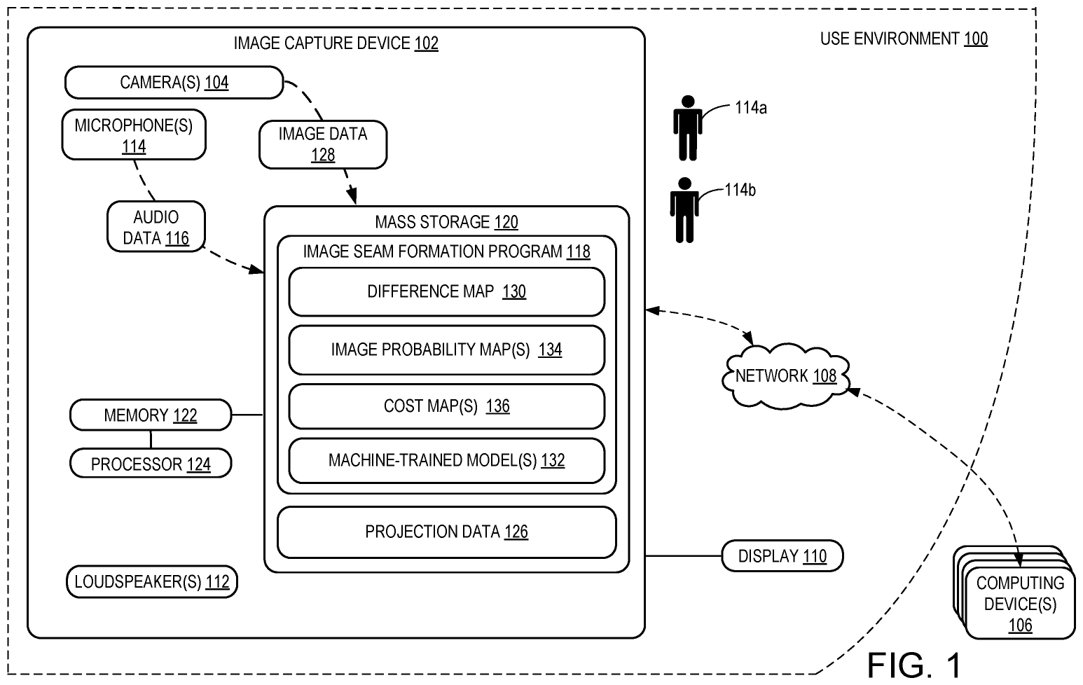

FIG. 1 schematically shows an example use environment 100 in which an image capture device 102 stitches together images acquired by one or more cameras 104. The image capture device 102 may include components that communicatively couple the device with one or more other computing devices 106. For example, the image capture device 102 may be communicatively coupled with the other computing device(s) 106 via a network 108. In some examples, the network 108 may take the form of a local area network (LAN), wide area network (WAN), wired network, wireless network, personal area network, or a combination thereof, and may include the Internet.

As described in more detail below, the image capture device 102 includes one or more cameras 104 that each acquire one or more images of the use environment 100. In some examples, the camera(s) 104 comprises one or more visible light cameras configured to capture visible light image data from the use environment 100. Example visible light cameras include an RBG camera and/or a grayscale camera. The camera(s) 104 also may include one or more depth image sensors configured to capture depth image data for the use environment 100. Example depth image sensors include an infrared time-of-flight depth camera and an associated infrared illuminator, an infrared structured light depth camera and associated infrared illuminator, and a stereo camera arrangement.

The image capture device 102 may be communicatively coupled to a display 110, which may be integrated with the image capture device 102 (e.g. within a shared enclosure) or may be peripheral to the image capture device 102. The image capture device 102 also may include one or more electroacoustic transducers, or loudspeakers 112, to output audio. In one specific example in which the image capture device 102 functions as a video conferencing device, the loudspeakers 112 receive audio from computing device(s) 106 and output the audio received, such that participants 114 in the use environment 100 may conduct a video conference with one or more remote participants associated with computing device(s) 106. Further, the image capture device 102 may include one or more microphone(s) 114 that receive audio data 116 from the use environment 100. While shown in FIG. 1 as integrated with the image capture device 102, in other examples one or more of the microphone(s) 114, camera(s) 104, and/or loudspeaker(s) 112 may be separate from and communicatively coupled to the image capture device 102.

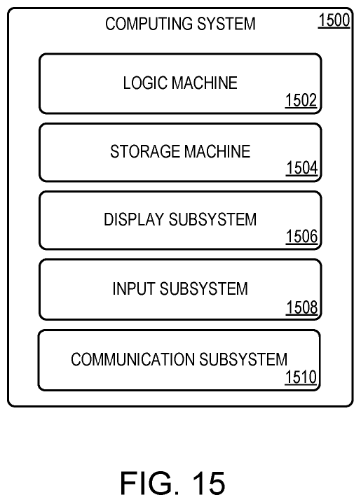

The image capture device 102 includes an image seam formation program 118 that may be stored in mass storage 120 of the image capture device 102. The image seam formation program 118 may be loaded into memory 122 and executed by a processor 124 of the image capture device 102 to perform one or more of the methods and processes described in more detail below. In other examples, the image seam formation program 118 or portions of the program may be hosted by and executed on an edge or remote computing device, such as a computing device 106, that is communicatively coupled to image capture device 102. Additional details regarding components and computing aspects of the image capture device 102 and computing device(s) 106 are described in more detail below with reference to FIG. 15.

The mass storage 120 of image capture device 102 further may store projection data 126 describing projections for one or more cameras 104. For example, for a fixed-location camera, the projection data 126 may store camera calibration data, a position of the camera, a rotation of the camera, and/or any other suitable parameter regarding the camera useable for projecting an image acquired by the camera.

As described in more detail below, image data 128 from the camera(s) 104 may be used by the image seam formation program 118 to generate a difference map 130 describing pixel-by-pixel differences, block-level (plural pixels) differences, or any other measure for differences in intensity, color, or other image characteristic(s) between two images. Such image data 128 also may be used to construct still images and/or video images of the use environment 100.

The image data 128 also may be used by the image seam formation program 118 to identify semantically understood surfaces, people, and/or other objects, for example, via a machine trained model(s) 132. The machine-trained model(s) 132 may include a neural network(s), such as a convolution neural network(s), an object detection algorithm(s), a pose detection algorithm(s), and/or any other suitable architecture for identifying and classifying pixels of an image. As described in more detail below, the image seam formation program 118 may be configured to generate, for each image obtained, an image probability map(s) 134 describing a likelihood that pixels within the image correspond to one or more classes of objects. In some examples, classes of objects within the use environment 100 may be identified based on depth maps derived from visible light image data provided by a visible light camera(s). In other examples, classes of objects within the use environment 100 may be identified based on depth maps derived from depth image data provide by a depth camera(s).

The image seam formation program may further be configured to generate a cost map 136 for at least a region in which two adjacent images overlap. As described in the use case examples provided below, based on the cost map, a path is identified for joining the first image and the second image within the region in which the images overlap. A seam is then formed based on the identified path.

In some examples, the image capture device 102 may comprise a standalone computing system, such as a standalone video conference device, a mobile phone, or a tablet computing device. In some examples, the image capture device 102 may comprise a component of another computing device, such as a set-top box, gaming system, autonomous automobile, surveillance system, unmanned aerial vehicle or drone, interactive television, interactive whiteboard, or other like device.

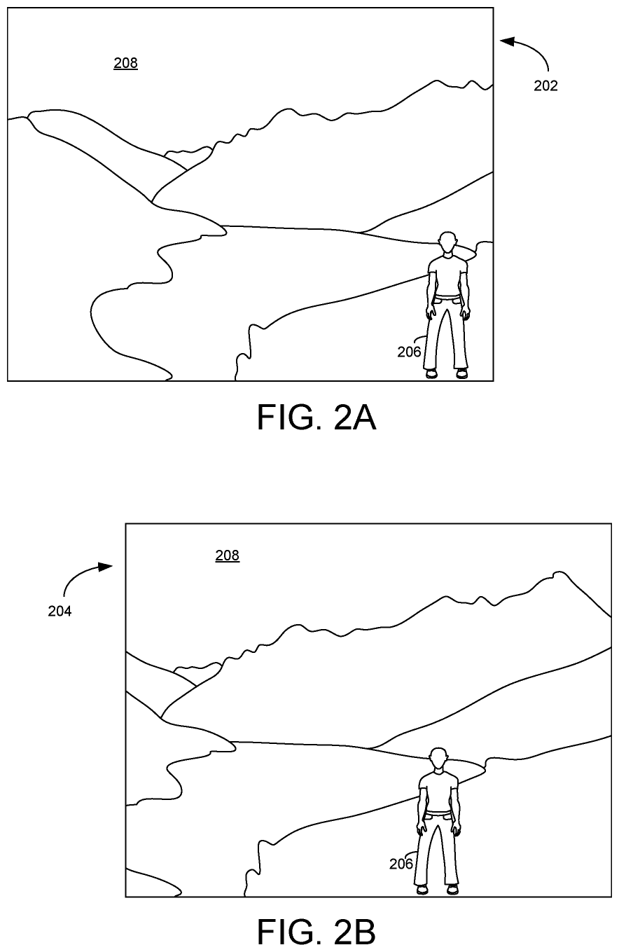

As mentioned above, two or more images acquired by a single camera may be stitched together to form a panoramic image. FIGS. 2A and 2B schematically show example images 202, 204 captured by the same camera at different points in time. In this example, a user acquires a first image 202 (FIG. 2A) of a first portion of a scene and moves the camera to their right during image acquisition to obtain a second image 204 (FIG. 2B) of a second portion of the scene, where the second portion of the scene partially overlaps the first portion of the scene. As the camera did not undergo pure rotational motion during image acquisition, a stationary person 206 in the image foreground appears to be in a different location in each image frame with respect to the background 208.

To stitch together the first image 202 and the second image 204, a computing device integrated with the camera generates for each image, via an image seam formation program 118, an image probability map 134 describing a likelihood that pixels within the image correspond to one or more classes of objects. While described herein in the context of an image probability map, it will be understood that any other suitable method may be used to determine a likelihood that pixels within the first image and/or the second image correspond to one or more classes of objects. The one or more classes of objects may include people, vehicles, animals, office supplies, and/or any other object classification for which an observer may easily perceive visual deviations/distortions. In some instances, the one or more classes of objects may be weighted such that a class(es) is given a higher priority for seam avoidance than another class(es). For example, a person identified in an image may be given greater priority for not placing a seam through the person than a cloud or other recognized object. As noted above, while described herein in the context of a computing device that receives image data from an integrated camera, it will be understood that a computing device may comprise any other suitable form. For example, the computing device may comprise a laptop computer, a desktop computer, an edge device, and/or a remote computing device that receives image data from a camera via a network.

Each image probability map 134 may take the form of a grayscale image in which probability values are represented by pixel intensity. In some instances, an image probability map 134 comprises a pixel-by-pixel mask, where each pixel of the map includes a probability value corresponding to a pixel of the image. In other instances, the image probability map 134 may comprise a lower resolution than the image, where each pixel of the image probability map includes a probability value corresponding to a subset of pixels of the image.

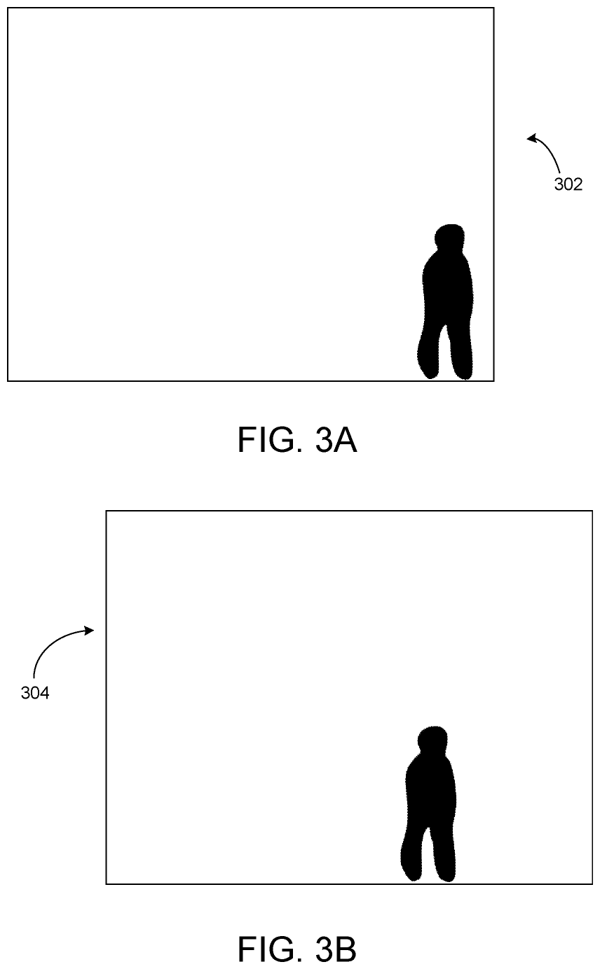

FIG. 3A depicts an example first image probability map 302 describing a likelihood that pixels of the first image 202 (FIG. 2A) belong to the class “person.” Likewise, FIG. 3B depicts an example second image probability map 304 describing a likelihood that pixels of the second image 204 (FIG. 2B) belong to the class “person.” In FIGS. 3A and 3B, regions of low intensity (white) in each image probability map 302, 304 represent lower probabilities of a pixel corresponding to a person than regions of high intensity (black). Further, the first image probability map 302 and the second image probability map 304 each include feathering around a subset of high intensity pixels, which may indicate a buffer zone.

For each image 202, 204, the computing device may generate the corresponding image probability map 302, 304 in any suitable manner. In some examples, generating an image probability map for an image comprises processing the image via a semantic image segmentation network trained to output an image probability map in which each pixel is labeled with a semantic class and a probability that a corresponding pixel or subset of pixels of the image belongs to the recognized semantic class.

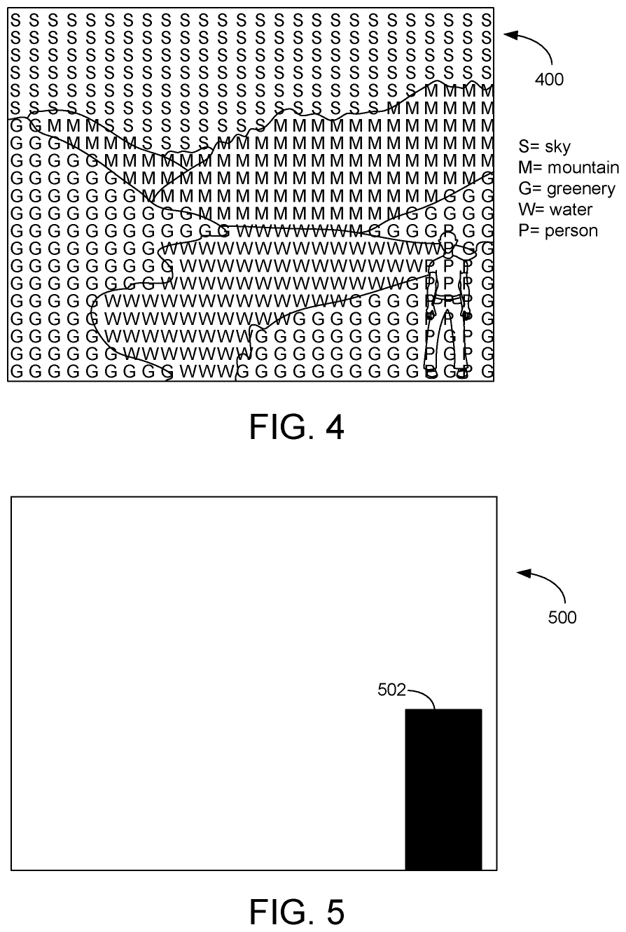

FIG. 4 depicts an example output of an image segmentation network for the first image 202 (FIG. 2A). In this example, pixels of the image probability map 400, shown as superimposed with the first image 202, are labeled according to recognized semantic classes of sky (S), mountain (M), greenery (G), water (W), and person (P). Each pixel or subset of pixels of the image probability map 400 further comprises a probability value (not shown) that the corresponding pixel of the first image 202 belongs to the recognized semantic class. The probability value may take any suitable form, including a percentage or a binary determination.

A semantic image segmentation network may comprise any suitable architecture, including any suitable type and quantity of machine-trained models. Examples include convolution neural networks, such as Residual Networks (ResNet), Inception, and DeepLab. Further, an image segmentation network may segment an image according to any other classification(s), in addition or alternatively to the semantically understood classes shown in FIG. 4.

In addition or alternatively to semantic image segmentation, the image seam formation program 118 may store instructions for generating an image probability map 134 via object detection and/or pose estimation. An example object detection process may comprise utilizing an object detection algorithm to identify instances of real-world objects (e.g. faces, buildings, vehicles, etc.) via edge detection and/or blob analysis, and to compare the detected edges and/or blob(s) to a library of object classifications. In an example pose estimation process, an object identified within an image (e.g. via edge detection, blob analysis, or any other suitable method) may be fit to a skeletal model represented by a collection of nodes that are connected in a form that resembles the human body.

As an alternative to the human forms depicted in the example image probability maps shown in FIGS. 3A and 3B, an image probability map may comprise a bounding box (or other general shape) spanning pixels of the image classified as belonging to an object. FIG. 5 depicts an example image probability map 500 comprising a bounding box 502 superimposed over the stationary person 206 in the first image 202 (FIG. 2A). The bounding box 502 creates a probability field for pixels of the image which may correspond to the stationary person 206. In other examples, a bounding box may additionally or alternatively create a probability field for pixels corresponding to any other class(es) of objects in which a seam may create artifacts or other distortions that may be visually perceptible by an observer. In the example of FIG. 5, the image probability map 500 may comprise a uniform cost for all pixels of the bounding box 502, e.g., a uniform probability of an object residing within the bounding box. In other examples, a bounding box may comprise nonuniform costs in which pixels of the bounding box are assigned different probability values.

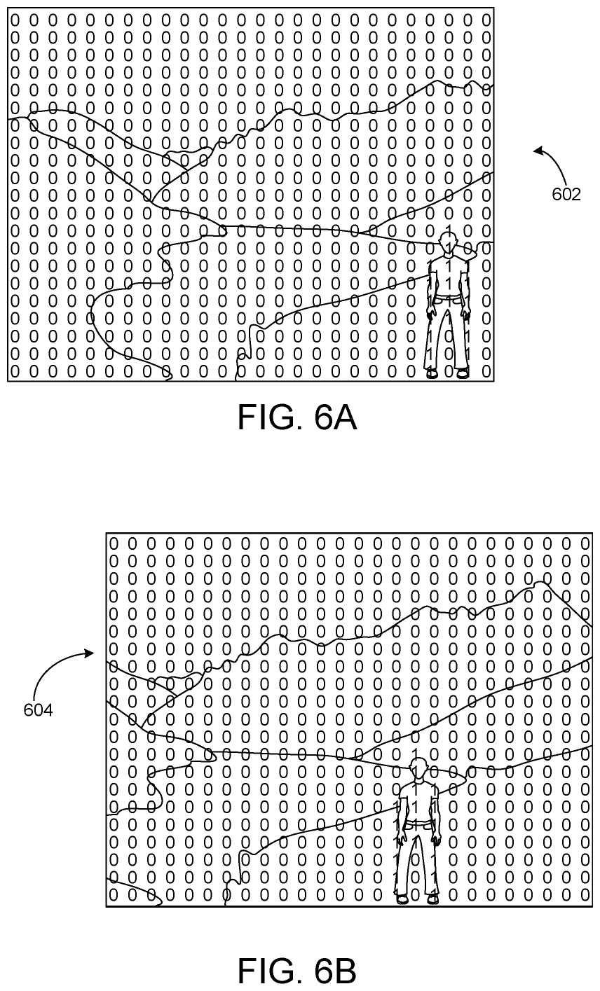

In some examples, probability values of an image probability map may include only those associated with a certain high-cost object(s), such as a person, detected within an image. FIGS. 6A and 6B respectively depict an example first image probability map 602 for the first image 202 (FIG. 2A) and an example second image probability map 604 for the second image 204 (FIG. 2B) in which the probability map identifies only the likelihood of each pixel corresponding to a person. Each pixel of the first image probability map 602 and the second image probability map 604 includes a probability value describing a likelihood that the corresponding pixel of the image 202, 204 belongs to a person. In this example, a probability value of 0 indicates that a pixel does not belong to a person, whereas a probability value of 1 indicates that a pixel does belong to a person. In other examples, any suitable range of probability values (e.g. a decimal or other representation of percent probability) may be used to indicate a likelihood that a pixel corresponds to a person or other high-cost object.

As mentioned above, an image seam formation program 118 generates a seam for joining adjacent images in a manner that helps prevent distortion to faces, people, and/or other high-cost objects. In some examples and prior to generating a seam, the image seam formation program 118 aligns, registers, and projects the first image 202 and the second image 204 onto a virtual canvas. As noted above, in the example of FIG. 2 the camera that captured the first image 202 and the second image 204 is moveable rather than fixed in location. Accordingly, the projections of each image may be unknown, as movement of the camera between image frames may be unknown.

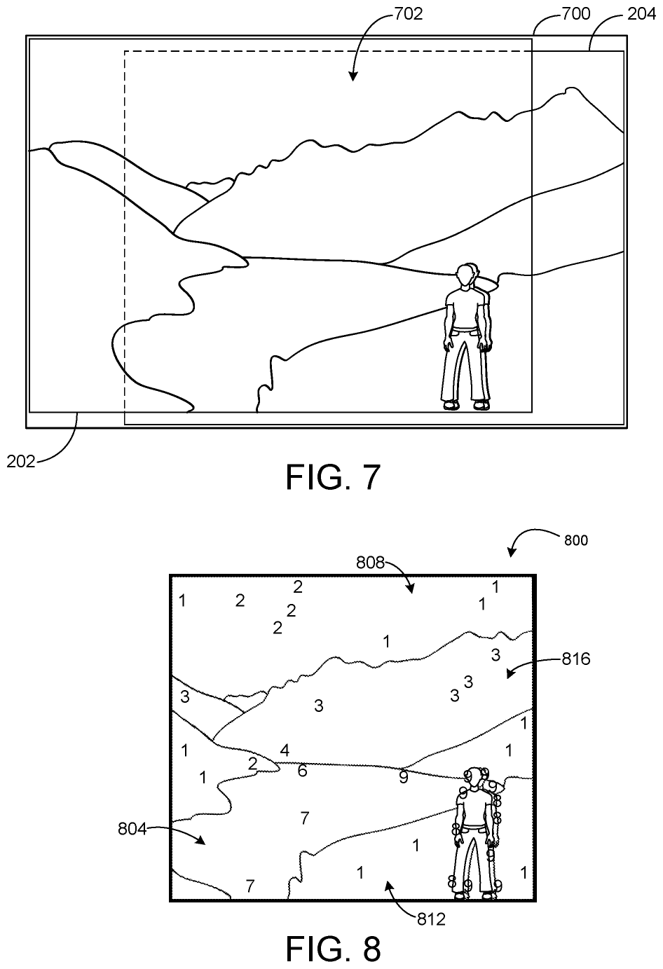

In some examples, the images 202, 204 may be aligned and registered via feature detection by aligning like features detected in each image. The image projections may then be determined based on a rotation and/or translation of each image 202, 204 used for alignment and registration. FIG. 7 depicts the first image 202 and the second image 204 projected on a virtual canvas 700 such that a portion of the first image 202 overlaps a portion of the second image 204. While not shown in this figure, the image seam formation program also may project the first image probability map and the second image probability map onto the canvas such that each pixel of the first image probability map aligns with a corresponding pixel(s) of the first image 202, and each pixel of the second image probability map aligns with a corresponding pixel(s) of the second image 204.

The image seam formation program 118 may generate a difference map for the images 202, 204 by subtracting at least a portion of the second image 204 from at least a portion of the first image 202. The difference map may represent a measure of similarity or dissimilarity between the first image 202 and the second image 204. For example, the difference map may be generated only for a region 702 in which the first image 202 and the second image 204 overlap. It will be understood that the term overlap does not necessarily indicate that the images 202, 204 are perfectly aligned, but rather that a region of each image captures a same portion of the real-world background.

FIG. 8 depicts an example difference map 800 for the region 702 (FIG. 7) in which the first image 202 and the second image 204 overlap. In this example, an intensity value for each pixel of a portion of the second image 204 is subtracted from an intensity value of a corresponding/overlapping pixel of the first image 202. The difference map 800 shown in FIG. 8 includes pixel values ranging from 0 to 10 that indicate low to high intensity differences between overlapping pixels of the first image 202 and the second image 204.

As the stationary person 206 appears in a different position relative to the camera in each image frame, the difference map 800 includes correspondingly high (8 to 9) difference values in a region bordering the stationary person. Likewise, as reflections and ripples in the water changed between image frames, the difference map 800 exhibits moderate to high (6 to 9) difference values for regions of the water 804. In contrast, regions corresponding to a clear sky 808, greenery 812, and mountains 816 exhibited relatively lower (1 to 4) difference values between image frames.

It will be understood that the pixel-wise difference values shown in FIG. 8 are exemplary, and in other examples an absolute difference value in intensity or another image characteristic (e.g. color) may be used for each pixel or group of pixels of the pixel-wise difference map. In a more specific example, the difference map may resemble a grayscale image in which low intensity pixels (e.g. white) represent minimal to no differences between overlapping pixels of the images 202, 204 and high intensity pixels (e.g. black) represent suitably high differences between the overlapping pixels. Further, while difference values are shown for only a sampling of pixels in FIG. 8, a difference map may include a difference value for each pixel or group of pixels, at least for pixels within a region of overlap between two adjacent images.

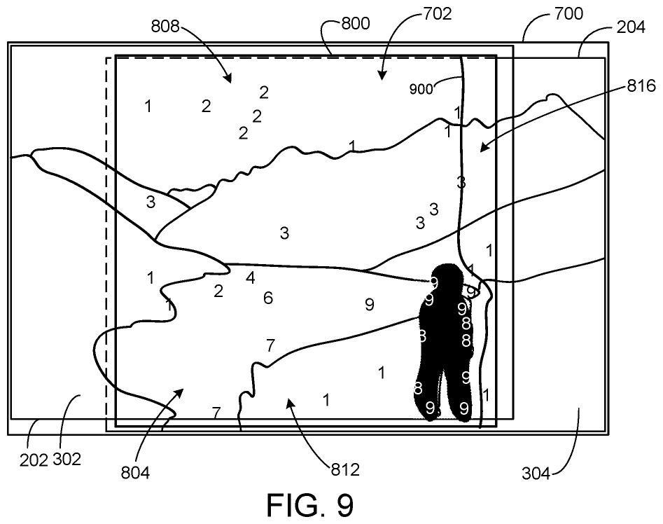

The image seam formation program 118 may also project the difference map 800 to overlay the first image 202, second image 204, first image probability map 302, and second image probability map 304, as shown in FIG. 9. In other examples, the difference map 800 may be calculated based on the projected pixels of the first image 202 and the second image 204 without also being projected onto the virtual canvas. In some examples, within the region 702 in which the first image 202 and the second image 204 overlap, a maximum probability may be calculated for each pixel within the region 702 based on the probabilities of the first image probability map 302 and the second image probability map 304.

The image seam formation program 118 may generate a cost map 136 as a function of the first image probability map 302 and the second image probability map 304, and optionally the difference map 800. This cost map may be generated for only pixels within the region in which the first image 202 and the second image 204 overlap, as a seam is to be placed within this region. In some examples, each pixel value of the cost map may comprise a sum of the pixel-wise difference between the adjacent images 202, 204 at that pixel and a probability of the pixel corresponding to one or more classes of objects as determined for each image 202, 204. This provides, for each pixel in a region in which the first image 202 and the second image 204 overlap, a cost value that accounts for a difference between the images at that pixel and the probability of each image containing a high-cost object at that pixel. While described herein with reference to a cost map, the image seam formation program 118 may identify a path for joining the first image 202 and the second image 204 in any other suitable manner based at least on the determined likelihood that pixels within the first image and/or the second image correspond to one or more classes of objects.

In some examples, the cost map 136 may be generated based on weighted values of the image probability maps, for example, to apply a greater cost to a seam intersecting one object as compared to another object. The image seam formation program 118 thus may determine, for each image, a gradient of a specific object's probability, and optimize the cost map based on the gradient determined. Additionally or as an alternative, the image seam formation program 118 may threshold an image probability map and apply a determination of whether or not a pixel belongs to a person or other high-cost object(s) based on the threshold. In a more specific example, the image seam formation program 118 may threshold an image probability map for probability values corresponding to a probability of a person, where any probability value below a 30% probability of a person is determined to not correspond to a person, and any probability value greater than or equal to 30% is determined to correspond to a person.

With continued reference to FIG. 9, based on the cost map, the image seam formation program 118 identifies a path 900, within the region 702 in which the first image 202 and the second image overlap 204, for joining the first image 202 and the second image 204. The path 900 may be identified by performing an optimization of the cost map, e.g. a global minimization of cost along the path 900. This may involve optimizing pixel differences at locations outside a boundary of a high-cost object(s) while navigating the path 900 around a high-cost object(s). In FIG. 9, the path 900 traverses the sky 808, mountains 816, and greenery 812 without intersecting the water 804 or the person identified as high-cost regions via the cost map. In this example, as the path 900 forms a boundary at which each image is cut and joined together, all pixels corresponding to the water and the person (the high-cost regions), in a joined image, will be pixels of the first image 202. In this manner, the water 804 and the person may be located completely on one side of the path 900.

In some examples, a path can be weighted by tuning the cost map. For example, the image seam formation program 118 may tune the cost map 136 to associate different weights with different identified objects within an image. When adding the image probability values to the pixel-wise difference value for a pixel of the cost map, such tuning may involve multiplying a cost of a certain probable object with a constant that increases or decreases the cost of the object in relation to another object class(es). In some examples, such tuning may restrict a path from intersecting certain high-cost objects, such as people and/or faces. In addition or alternatively, such tuning may permit a path to intersect certain objects, such as furniture. In other instances, such tuning may selectively permit a path to intersect a high-cost object. For example, a path that navigates around a person's head and thus does not distort facial geometry may be permitted to cut through the person's midsection (e.g. a solid color shirt) and remain relatively hidden if pixel-wise differences in an overlapping region corresponding to the person's midsection are also suitably low.

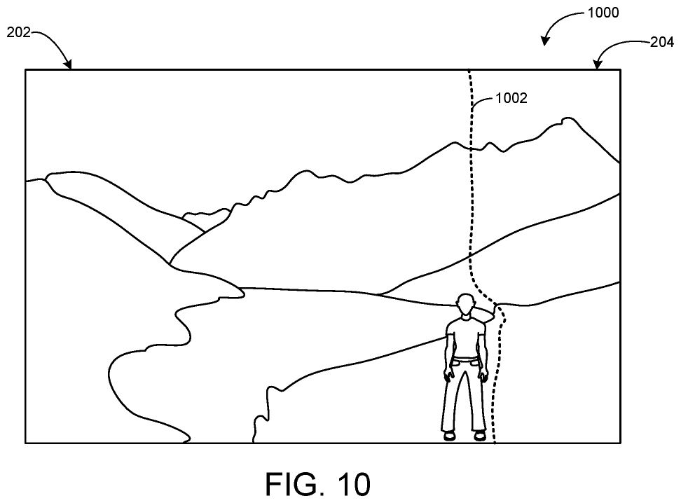

In any instance, based on the path 900 identified, the image seam formation program 118 cuts the first image 202 and the second image 204 along the path 900 and forms a seam to join the first image to the second image along this path. FIG. 10 depicts an example panoramic image 1000 formed by joining a cut portion of the first image 202 to a cut portion of the second image 204 via a seam 1002. While shown as a dotted line in the example of FIG. 10, it will be understood that the seam 1002 may be imperceptible to the human eye.

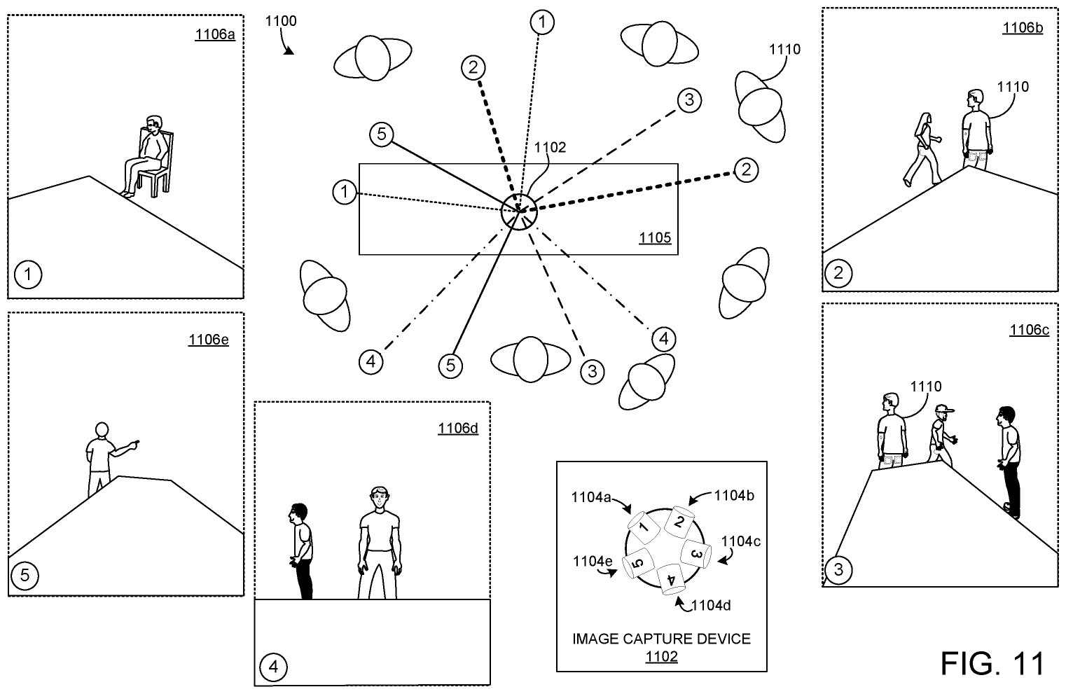

In the examples described above, an image seam formation program forms a seam between adjacent images acquired by the same camera, which may or may not be consecutive image frames. In some examples, a computing device may form a panoramic image from images captured by multiple cameras. FIG. 11 schematically shows an example use environment 1100 for an image capture device 1102 comprising a plurality of outward-facing cameras 1104a-1104e, where adjacent cameras comprise a partially overlapping field of view of the use environment 1100. A field of view of a first camera 1104a is indicated by dotted cone 1-1, a field of view of a second camera 1104b is indicated by dashed cone 2-2, a field of view of a third camera 1104c is indicated by dashed cone 3-3, a field of view of a fourth camera 1104d is indicated by dashed/dotted cone 4-4, and a field of view of a fifth camera is indicated by solid cone 5-5.

In this example, the use environment 1100 comprises a conference room in which multiple people stand or sit around a conference table 1105. The image capture device 1102 rests on a top surface of the conference table 1105 and fixed-location cameras 1104a-1104e synchronously acquire images 1106a-1106e of the use environment 1100. Each camera 1104a-1104e views a portion of the use environment 1100 within a cone, and a corresponding projection of this portion of the use environment 1100 is generated. Each of the images 1106a-1106e captured by each camera 1104a-1104e may take the form of a plane. The corresponding projections may take any suitable form, such as rectilinear projections, curved projections, and stereographic projections, for example. Creating a panoramic image via two or more of the images 1106a-1106e thus may involve simulating a virtual camera in which the captured images are suitably projected.

In one example, a cylindrical or partial cylindrical projection may be utilized. An image seam formation program 118 may simulate the virtual camera by setting a horizontal field of view and a vertical field of view of a virtual image canvas for forming a panoramic image. As an example, the virtual image canvas may comprise a vertical field of view of 90 degrees and a horizontal field of view of 180 degrees. As another example, a virtual image canvas for depicting the entire use environment 1100 may comprise a horizontal field of view of 360 degrees.

The image seam formation program 118 obtains an image 1106a-1106e from each of two or more cameras 1104a-1104e and generates an image probability map for each image that will be included in the panoramic image, as described above. In other examples, the image seam formation program 118 may determine a likelihood that pixels within the first image and/or the second image correspond to one or more classes of objects in any other suitable manner. The image seam formation program 118 may designate a selected image obtained as a centermost image for the image canvas. With reference to FIGS. 11 through 13, the first image 1106a obtained from the first camera 1104a is selected as the centermost image. The image seam formation program aligns and registers the selected image with one or more images adjacent to the selected image. In this example, the second image 1106b obtained from the second camera 1104b and the fifth image 1106e obtained from the fifth camera 1104e are each adjacent to the selected image 1106a. For brevity, the following description will reference the second image 1106b as the adjacent image.

Camera locations, directions, and/or other parameters for each of the fixed-position cameras 1104a-1104e are known or assumed to be known, e.g. based on a calibration of the cameras 1104a-1104e. In this example, the selected image 1106a and the second image 1106b may be aligned and registered by performing a translation and/or rotation based on known locations, positions, and/or another parameter(s) of the first camera 1104a and the second camera 1104b. The image seam formation program 118 may apply any other suitable mapping to the images 1106a, 1106b, in other examples.

Based on the rotation and/or translation performed to align the selected image 1106a with the second image 1106b, the image seam formation program projects the selected image 1106a and the second image 1106b onto the virtual image canvas such that a portion of the selected image 1106a overlaps a portion of the second image 1106b. A probability map for the selected image 1106a and a probability map for the second image 1106b are also projected with the images 1106a, 1106b such that each probability value overlaps the corresponding pixel(s) of the corresponding image, as described above. The image seam formation program 118 also may calculate differences between overlapping pixels of the selected image 1106a and the second image 1106b, on a pixel-by-pixel basis or in any other suitable manner. Based on these differences, the image seam formation program 118 may generate a difference map, which may take the form of a grayscale image. Further, as described above, the image seam formation program 118 may generate a cost map, at least for the region in which the images 1106a, 1106b overlap, based on a determined likelihood that pixels within the first image and/or the second image correspond to one or more classes of objects. This may be determined, for example, by the image probability map for each image 1106a, 1106b. The image seam formation program 118 may also generate the cost map based on the difference map, such that a cost associated with a difference(s) between overlapping pixels of the first image and the second image is combined with a cost of a pixel corresponding to one or more classes of objects.

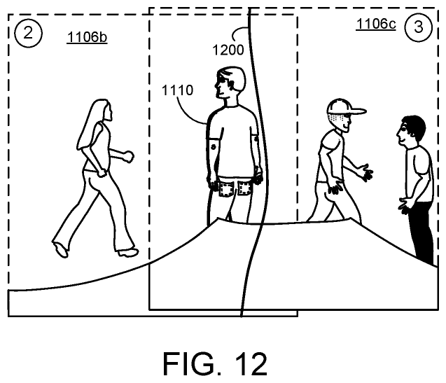

The image seam formation program 118 may repeat this process until each image to be included in the panoramic image is aligned, registered, and projected onto the virtual image canvas and a cost map is generated for a region in which the image and an adjacent image overlap. With reference to FIG. 12, a schematic illustration is provided of the second image 1106b and the third image 1106c as projected onto the virtual image canvas, as described above. The cost map generated for the overlapping region of these two images may be utilized as described above to identify a high-cost object(s) in the region, such as person 1110, and to identify a path for joining the second image 1106b to the third image 1106c that does not intersect such high-cost object(s). In FIG. 12, a path 1200 identified for joining the images 1106b, 1106c traverses a perimeter of person 1110 without intersecting the person.

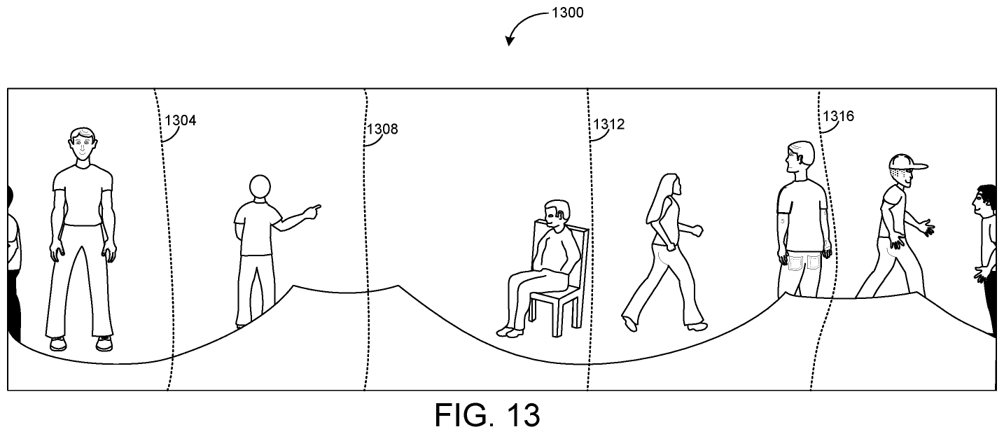

As noted above, the path identified via the cost map forms a boundary at which the adjacent images are cut and joined. Utilizing this path, a seam formed by joining the images may be placed in a manner that does not intersect a high-cost object(s). FIG. 13 shows a panoramic image in which images 1106a-1106e are joined together via seams 1304, 1308, 1312 and 1316 that do not intersect any of the people detected within the images 1106a-1106e.

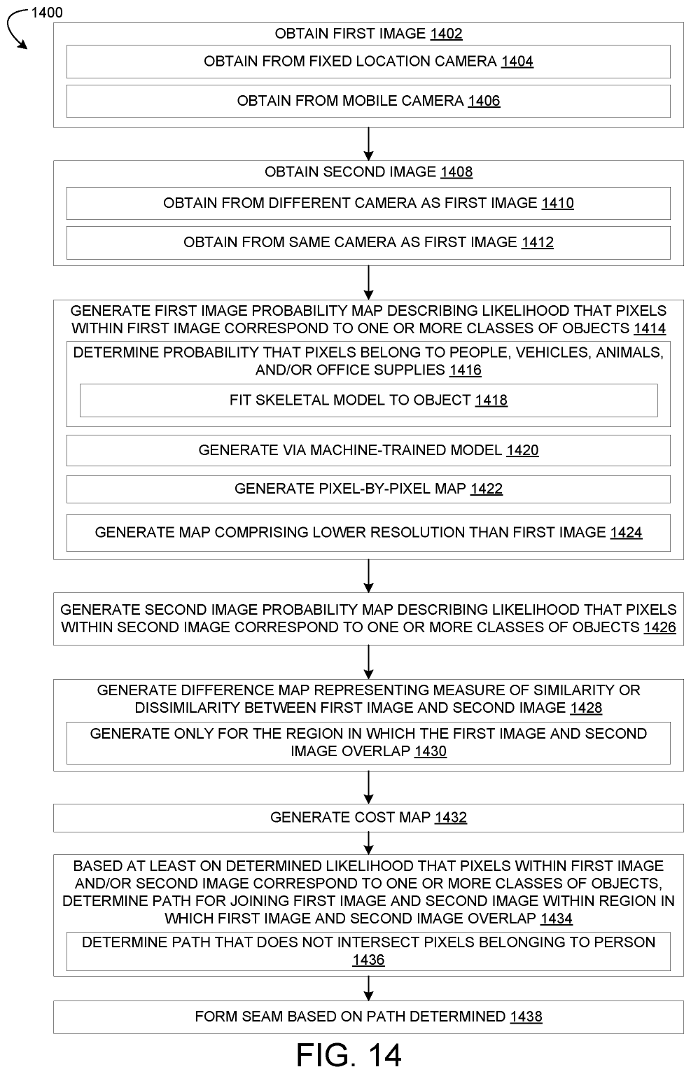

FIG. 14 is a flowchart illustrating an example method 1400 for joining adjacent images according to the examples described herein. Method 1400 may be implemented as stored instructions executable by a processor of an image capture device, such as image capture device 102, image capture device 1102, as well as other image capture devices (e.g. a tablet, a mobile phone, an autonomous vehicle, a surveillance system, etc.) In addition or alternatively, aspects of method 1400 may be implemented via a computing device that receives image data from one or more cameras via a wired or wireless connection. At 1402, method 1400 comprises obtaining a first image of a first portion of a real-world scene. Any suitable image may be obtained, including a visible light image (grayscale or RGB) and/or a depth image. In some examples, obtaining the first image may comprise obtaining the first image from a fixed-location camera, as indicated at 1404. In other examples, obtaining the first image may comprise obtaining the first image from a mobile camera, such as a camera of a mobile device (e.g. a smartphone, tablet, or other mobile image capture device), as indicated at 1406.

At 1408, method 1400 comprises obtaining a second image of a second portion of the real-world scene, where the second portion of the real-world scene at least partially overlaps the first portion of the real-world scene. It will be understood that the term “overlaps” indicates that a same portion of the real-world scene is captured in at least a portion of each adjacent image and does not necessarily indicate that the images are aligned. In some examples, obtaining the second image comprises obtaining the second image from a different camera than the first image, as indicated at 1410. In a more specific example, a computing device may obtain the first image from a first fixed-location camera and may obtain the second image from a second fixed-location camera. Alternatively, obtaining the second image may comprise obtaining the second image from a same camera as the first image, as indicated at 1412. When obtained from the same camera, the first and second images may be consecutive image frames, or may be nonconsecutive image frames in which at least a portion of the first image and a portion of the second image overlap.

At 1414, method 1400 may comprise determining a likelihood that pixels within the first image correspond to one or more classes of objects, for example, by generating a first image probability map describing the likelihood that pixels of the first image correspond to the one or more classes of objects. In some examples, generating the first image probability map comprises determining a probability that pixels of the first image belong to people, vehicles (e.g. automobiles, bicycles, etc.), animals, and/or office supplies, as indicated at 1416. In a more specific example, determining the probability that pixels of the first image belong to a person may comprise fitting a skeletal model to an object identified within the first image, as indicated at 1418. In any instance, determining probability values for the first image probability map may comprise determining such values via a machine-trained model(s), as indicated at 1420. In some examples, generating the first image probability map comprises generating a pixel-by-pixel map in which each pixel of the first image probability map corresponds to a pixel of the first image, as indicated at 1422. In other examples, as indicated at 1424, generating the first image probability map comprises generating a map comprising lower resolution than the first image, where each pixel of the first image probability map corresponds to a subset of pixels of the first image.

At 1426, method 1400 may comprise determining a likelihood that pixels within the second image correspond to one or more classes of objects, for example, by generating a second image probability map describing the likelihood that pixels of the second image correspond to the one or more classes of objects. The second image probability map may be generated in any suitable manner, including the examples described herein with reference to generating the first image probability map (1414 through 1424). It will be understood that any other suitable method(s) may be used to determine a likelihood that pixels within the first image and/or the second image correspond to one or more classes of objects, which may or may not involve generating a first image probability map and/or a second image probability map.

At 1428, method 1400 may comprise generating a difference map representing a measure of similarity or dissimilarity between the first image and second image, for example, by subtracting at least a portion of the second image from at least a portion of the first image. In some examples, generating the difference map comprises generating a difference map for only the region in which the first image and the second image overlap, as indicated at 1430.

At 1432, method 1400 may comprise generating a cost map as a function of a determined likelihood that pixels within the first image and/or the second image correspond to one or more classes of objects. Generating a cost map may be further based on the measure of similarity or dissimilarity between the first image and the second image. For example, generating the cost map may comprise adding the first image probability map and the second image probability map to the difference map. As described above, a cost of a certain object(s) may be weighted such that placing a seam that intersects the certain object(s) is more or less costly than another object. In any instance, based at least on the determined likelihood that pixels within the first image and/or the second image correspond to one or more classes of objects, method 1400 comprises, at 1434, determining a path for joining the first image and the second image in a region in which the first image and the second image overlap. In some examples, determining the path may comprise determining a path that does not intersect pixels belonging to a person, as indicated at 1436. In other examples, determining the path may comprise performing a global optimization of the cost map such that a path traverses, over the length of the path, a lowest sum of pixel-wise differences in the region in which the first image and the second image overlap. In a more specific example, determining the path may comprise determining based further upon the difference map.

At 1438, method 1400 comprises forming a seam based on the path determined for joining the first image and the second image. As described above, forming the seam comprises cutting and joining the first image and the second image along the path identified, such that pixels located on one side of the seam correspond to the first image and pixels located on an opposing side of the seam correspond to the second image. In some examples, forming the seam comprises forming the seam along a cost-optimized path that navigates around any pixels corresponding to a person and/or another high-cost object(s).

It will be appreciated that method 1400 is provided by way of example and is not meant to be limiting. Therefore, it is to be understood that method 1400 may include additional and/or alternative steps relative to those illustrated in FIG. 14. Further, it is to be understood that method 1400 may be performed in any suitable order. Further still, it is to be understood that one or more steps may be omitted from method 1400 without departing from the scope of this disclosure.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 15 schematically shows a non-limiting embodiment of a computing system 1500 that can enact one or more of the methods and processes described above. Computing system 1500 is shown in simplified form. Computing system 1500 may take the form of one or more personal computers, server computers, tablet computers, home-entertainment computers, network computing devices, gaming devices, mobile computing devices, mobile communication devices (e.g., smart phone), and/or other computing devices.

Computing system 1500 includes a logic machine 1502 and a storage machine 1504. Computing system 1500 may optionally include a display subsystem 1506, input subsystem 1508, communication subsystem 1510, and/or other components not shown in FIG. 15.

Logic machine 1502 includes one or more physical devices configured to execute instructions. For example, the logic machine 1502 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 1502 may include one or more processors configured to execute software instructions. Additionally or alternatively, the logic machine 1502 may include one or more hardware or firmware logic machines configured to execute hardware or firmware instructions. Processors of the logic machine 1502 may be single-core or multi-core, and the instructions executed thereon may be configured for sequential, parallel, and/or distributed processing. Individual components of the logic machine 1502 optionally may be distributed among two or more separate devices, which may be remotely located and/or configured for coordinated processing. Aspects of the logic machine 1502 may be virtualized and executed by remotely accessible, networked computing devices configured in a cloud-computing configuration.

Storage machine 1504 includes one or more physical devices configured to hold instructions executable by the logic machine 1502 to implement the methods and processes described herein. When such methods and processes are implemented, the state of storage machine 1504 may be transformed—e.g., to hold different data.

Storage machine 1504 may include removable and/or built-in devices. Storage machine 1504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1504 may include volatile, nonvolatile, dynamic, static, read/write, read-only, random-access, sequential-access, location-addressable, file-addressable, and/or content-addressable devices.

It will be appreciated that storage machine 1504 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1502 and storage machine 1504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1500 implemented to perform a particular function. In some cases, a program may be instantiated via logic machine 1502 executing instructions held by storage machine 1504. It will be understood that different programs may be instantiated from the same application, service, code block, object, library, routine, API, function, etc. Likewise, the same program may be instantiated by different applications, services, code blocks, objects, routines, APIs, functions, etc. The term “program” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1506 may be used to present a visual representation of data held by storage machine 1504. This visual representation may take the form of a graphical user interface (GUI). As the herein described methods and processes change the data held by the storage machine, and thus transform the state of the storage machine, the state of display subsystem 1506 may likewise be transformed to visually represent changes in the underlying data. Display subsystem 1506 may include one or more display devices utilizing virtually any type of technology. Such display devices may be combined with logic machine 1502 and/or storage machine 1504 in a shared enclosure, or such display devices may be peripheral display devices.

When included, input subsystem 1508 may comprise or interface with one or more user-input devices such as a keyboard, mouse, touch screen, or game controller. In some embodiments, the input subsystem 1508 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1510 may be configured to communicatively couple computing system 1500 with one or more other computing devices. Communication subsystem 1510 may include wired and/or wireless communication devices compatible with one or more different communication protocols. As non-limiting examples, the communication subsystem 1510 may be configured for communication via a wireless telephone network, or a wired or wireless local- or wide-area network. In some embodiments, the communication subsystem 1510 may allow computing system 1500 to send and/or receive messages to and/or from other devices via a network such as the Internet.

Another example provides a method enacted on a computing device, the method comprising obtaining a first image of a first portion of a scene, obtaining a second image of a second portion of the scene, the second portion of the scene at least partially overlapping the first portion of the scene, based on a determined likelihood that pixels within the first image and/or the second image correspond to one or more classes of objects, determining a path for joining the first image and the second image within a region in which the first image and the second image overlap, and forming a seam based on the path determined for joining the first image and the second image. In such an example, obtaining the first image may additionally or alternatively comprise obtaining the first image from a first camera, and obtaining the second image may additionally or alternatively comprise obtaining the second image from the first camera or a second camera. In such an example, the method may additionally or alternatively comprise generating a first image probability map describing a first determined likelihood that pixels within the first image correspond to the one or more classes of objects, and generating a second image probability map describing a second determined likelihood that pixels within the second image correspond to the one or more classes of objects. In such an example, generating the first image probability map may additionally or alternatively comprise determining a probability that pixels of the first image belong to the one or more classes of objects, the one or more classes of objects comprising people, vehicles, animals, and/or office supplies. In such an example, determining the likelihood that pixels of the first image belong to the one or more classes of objects may additionally or alternatively comprise fitting a skeletal model to an object in the first image. In such an example, determining the path for joining the first image and the second image may additionally or alternatively comprise determining a path that does not intersect pixels determined to belong to a person. In such an example, generating the first image probability map may additionally or alternatively comprise generating a map comprising a lower resolution than the first image. In such an example, generating the first image probability map may additionally or alternatively comprise generating a pixel-by-pixel map comprising, for each pixel, a probability that a corresponding pixel of the first image belongs to the one or more classes of objects. In such an example, the method may additionally or alternatively comprise generating a difference map representing a measure of similarity or dissimilarity between the first image and the second image by subtracting at least a portion of the second image from at least a portion of the first image, and determining the path may additionally or alternatively comprise determining based on the difference map. In such an example, generating the difference map may additionally or alternatively comprise generating the difference map only for the region in which the first image and the second image overlap.

Another example provides a computing device comprising a logic subsystem comprising one or more processors, and memory storing instructions executable by the logic subsystem to obtain a first image of a first portion of a scene, obtain a second image of a second portion of the scene, the second portion of the scene at least partially overlapping the first portion of the scene, based on a determined likelihood that pixels within the first image and/or the second image correspond to one or more classes of objects, determine a path for joining the first image and the second image within a region in which the first image and the second image overlap, and form a seam based on the path identified for joining the first image and the second image. In such an example, the instructions may additionally or alternatively be executable to obtain the first image from a first camera, and to obtain the second image from the first camera or a second camera. In such an example, the instructions may additionally or alternatively be executable to generate a first image probability map describing the first determined likelihood that pixels within the first image correspond to the one or more classes of objects, and generate a second image probability map describing the second determined likelihood that pixels within the second image correspond to the one or more classes of objects. In such an example, the instructions may additionally or alternatively be executable to generate the first image probability map by generating a pixel-by-pixel map comprising, for each pixel of the first image probability map, a probability that a corresponding pixel of the first image belongs to the one or more classes of objects. In such an example, the instructions may additionally or alternatively be executable to generate the first image probability map by determining a probability that pixels of the first image belong to the one or more classes of objects, the one or more classes of objects comprising people, vehicles, animals, and/or office supplies. In such an example, the instructions may additionally or alternatively be executable to determine the likelihood that pixels of the first image belong to the one or more classes of objects by fitting a skeletal model to an object in the first image. In such an example, the instructions may additionally or alternatively be executable to determine the path for joining the first image and the second image by determining a path that does not intersect pixels determined to belong to people. In such an example, the instructions may additionally or alternatively be executable to generate a difference map representing a measure of similarity or dissimilarity between the first image and the second image by subtracting at least a portion of the second image from at least a portion of the first image, and the instructions may additionally or alternatively be executable to determine the path based on the difference map. In such an example, the instructions may additionally or alternatively be executable to generate the difference map only for the region in which the first image and the second image overlap.

Another example provides a computing device, comprising a logic subsystem comprising one or more processors, and memory storing instructions executable by the logic subsystem to obtain a first image, obtain a second image, and based a determined likelihood that pixels within the first image and/or the second image correspond to a person class, form a seam that joins the first image and the second image along a cost-optimized path, the cost-optimized path navigating around any pixels corresponding to the person class.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method enacted on a computing device, the method comprising:
obtaining a first image of a first portion of a scene;
obtaining a second image of a second portion of the scene, the second portion of the scene at least partially overlapping the first portion of the scene;
based on a determined likelihood that pixels within the first image and/or the second image correspond to one or more classes of objects, determining a path for joining the first image and the second image within a region in which the first image and the second image overlap; and
forming a seam based on the path determined for joining the first image and the second image.

2. The method of claim 1, further comprising generating a difference map representing a measure of similarity or dissimilarity between the first image and the second image by subtracting at least a portion of the second image from at least a portion of the first image, and wherein determining the path further comprises determining the path based on the difference map.

3. The method of claim 2, wherein generating the difference map comprises generating the difference map only for the region in which the first image and the second image overlap.

4. The method of claim 1, wherein obtaining the first image comprises obtaining the first image from a first camera, and wherein obtaining the second image comprises obtaining the second image from the first camera or a second camera.

5. The method of claim 1, further comprising:
generating a first image probability map describing a first determined likelihood that pixels within the first image correspond to the one or more classes of objects; and
generating a second image probability map describing a second determined likelihood that pixels within the second image correspond to the one or more classes of objects.

6. The method of claim 5, wherein generating the first image probability map comprises determining a probability that pixels of the first image belong to the one or more classes of objects, the one or more classes of objects comprising people, vehicles, animals, and/or office supplies.

7. The method of claim 6, wherein determining the likelihood that pixels of the first image belong to the one or more classes of objects comprises fitting a skeletal model to an object in the first image.

8. The method of claim 6, wherein determining the path for joining the first image and the second image comprises determining a path that does not intersect pixels determined to belong to a person.

9. The method of claim 5, wherein generating the first image probability map comprises generating a map comprising a lower resolution than the first image.

10. The method of claim 5, wherein generating the first image probability map comprises generating a pixel-by-pixel map comprising, for each pixel, a probability that a corresponding pixel of the first image belongs to the one or more classes of objects.

11. A computing device, comprising:
a logic subsystem comprising one or more processors; and
memory storing instructions executable by the logic subsystem to:
obtain a first image of a first portion of a scene;
obtain a second image of a second portion of the scene, the second portion of the scene at least partially overlapping the first portion of the scene;
based on a determined likelihood that pixels within the first image and/or the second image correspond to one or more classes of objects, determine a path for joining the first image and the second image within a region in which the first image and the second image overlap; and
form a seam based on the path identified for joining the first image and the second image.

12. The computing device of claim 11, wherein the instructions are further executable to generate a difference map representing a measure of similarity or dissimilarity between the first image and the second image by subtracting at least a portion of the second image from at least a portion of the first image, and wherein the instructions are further executable to determine the path based on the difference map.

13. The computing device of claim 12, wherein the instructions are executable to generate the difference map only for the region in which the first image and the second image overlap.

14. The computing device of claim 11, wherein the instructions are executable to obtain the first image from a first camera, and to obtain the second image from the first camera or a second camera.

15. The computing device of claim 11, wherein the instructions are further executable to:
generate a first image probability map describing the first determined likelihood that pixels within the first image correspond to the one or more classes of objects; and
generate a second image probability map describing the second determined likelihood that pixels within the second image correspond to the one or more classes of objects.

16. The computing device of claim 15, wherein the instructions are executable to generate the first image probability map by generating a pixel-by-pixel map comprising, for each pixel of the first image probability map, a probability that a corresponding pixel of the first image belongs to the one or more classes of objects.

17. The computing device of claim 15, wherein the instructions are executable to generate the first image probability map by determining a probability that pixels of the first image belong to the one or more classes of objects, the one or more classes of objects comprising people, vehicles, animals, and/or office supplies.

18. The computing device of claim 17, wherein the instructions are executable to determine the likelihood that pixels of the first image belong to the one or more classes of objects by fitting a skeletal model to an object in the first image.

19. The computing device of claim 17, wherein the instructions are executable to determine the path for joining the first image and the second image by determining a path that does not intersect pixels determined to belong to people.

20. A computing device, comprising:
a logic subsystem comprising one or more processors; and
memory storing instructions executable by the logic subsystem to
obtain a first image;
obtain a second image; and
based on a determined likelihood that pixels within the first image and/or the second image correspond to a person class of objects, form a seam that joins the first image and the second image along a cost-optimized path, the cost-optimized path navigating around any pixels corresponding to the person class.
